(19) United States
(12) Patent Application Publication
(10) Pub. No.: US 2005/0188827 A1
(43) Pub. Date: Sep. 1, 2005

(54) Electrical discharge weapon for use as a forend grip of rifles

(76) Inventor: James F. McNulty JR., Calimesa, CA (US)

Correspondence Address: CHRISTIE, PARKER & HALE, LLP, PO BOX 7068, PASADENA, CA, 91109-7068, US

(21) Appl. No.: 10/929,618

(22) Filed: Aug. 30, 2004

Related U.S. Application Data
(63) Continuation-in-part of application No. 10/237,275, filed on Sep. 9, 2002, now Pat. No. 6,782,789.

(51) Int. Cl. B64D 1/04

(52) U.S. Cl. 89/1.11

(57) ABSTRACT

A combination weapon having a firearm with a barrel for firing a lethal projectile at a remote target and an electronic immobilization device positioned adjacent the barrel of the firearm for propelling electrically charged immobilizing non-lethal darts at the remote target and a trigger switch positioned on a surface of the electronic immobilization device which is to be operated by a hand which supports the weapon as opposed to the hand of the operator which fires the firearm.

### CROSS-REFERENCE TO RELATED APPLICATION(S)

This application is a continuation-in-part of U.S. application Ser. No. 10/237,275, filed Sep. 9, 2002.

### FIELD OF THE INVENTION

The present invention relates generally to apparatus for improving the versatility of rifles and more specifically to a forend grip configured to provide an electrical discharge weapon (i.e., TASER) which can receive either a cartridge having wire-tethered darts or a strobe light for signaling friends or for blinding enemies.

### BACKGROUND OF THE INVENTION

TASERs are weapons that can connect a disabling shock from a remote power supply to a violent assailant. The TASER launches a pair of electrically opposed darts with trailing wires from its power supply to an assailant to connect the assailant to the supply. TASERs have a lower lethality than conventional firearms. U.S. Pat. No. 3,803,463 was issued to Cover for the TASER in 1974. Since that time, the TASER has seen application in the United States as a law enforcement tool and the U.S. military has interest in the TASER for policing actions. TASERs are regularly used by peace officers to humanely capture suicidal or otherwise violent, even armed suspects, who may themselves be victims of intoxicants, drugs and/or emotional disturbance, without serious injury to suspects, officers or bystanders.

The main problem with the TASER, which has several tactical limitations, is that it is a discrete weapon. To be readily accessible for potential application, it must be separately holstered on the already quite limited space on a peace officer's utility belt or otherwise on the already quite limited space available for additional ordnance and weight on the person of the peace officer or soldier. Sufficient unused space to holster a TASER may not be available.

The TASER is necessarily a relatively large side arm. The space is needed to isolate the weapon's arcing high voltage circuitry. A typical TASER is described in U.S. Pat. No. 5,654,867 to Murray. At least partially for the above reasons, the TASER has only been deployed on a limited basis by law enforcement, and the TASER has not seen use in military policing actions. Deployment of conventional weapons could be reduced and countless lives saved and injuries avoided, if the TASER were more convenient for peace officers to bear and, thereby, more available for their use.

Combining the TASER with a conventional firearm can overcome the TASER's heretofore described storage and transport disadvantages. Several patentees, including the inventor herein, have previously attempted to combine the TASER with conventional firearms. U.S. Pat. No. 5,698,815 issued to Ragner. The Ragner apparatus has proved impractical and has never been commercially manufactured. U.S. Pat. No. 5,831,199 issued to McNulty. With the current state of the art, the ammunition cartridge described therein can only be manufactured as a minimum 38 to 40 mm diameter cartridge and is, therefore, only suitable for discharge through the barrels of grenade launchers and breech loading tear gas guns. Manufactured as the discharger cup described in the specification, the apparatus has no transport or storage advantages over discrete TASERs.

Combinations of lethal and non-lethal weapons are previously known, for example, combinations of assault rifles and electronic discharge immobilization weapons. U.S. Pat. No. 5,831,199 to McNulty and U.S. Pat. No. 5,962,806 to Coakley disclose cartridges which can be loaded into an M-203 grenade launcher to convert the launcher into an electronic discharge immobilization weapon. When operational, the M-203 grenade launcher is necessarily mounted beneath the barrel of an M-16A series automatic rifle. The M-203 grenade launcher is installed on an M-16A series weapon by connecting its rectangular forend grip about the barrel of the M-16 in lieu of its stock cylindrical forend grip. This design is intended to compensate somewhat for the reduction in stability of the combined M-16 and M-203 platform caused by the grasping pivot supporting the combinations forend now being at the cylindrical grenade launcher's barrel further beneath the axis of the M-16 barrel. With the box sleeve structure, the system of forces acting upon the M-16 and the M-203 combination when it is fired is now balanced to greatly reduce any torqueing movements of the combination.

These combinations have two major disadvantages. First, the M-203 grenade launcher is fired in the alternative to the M-16 full automatic rifle upon which it necessarily mounts by the shooter's removing his firing finger and hand from the trigger, trigger guard and/or trigger well of the M-16 rifle and, then, repositioning that hand and finger to the separate trigger of the M-203 grenade launcher. The shooter can either fire the M-16 rifle or the M-203 grenade launcher, but they cannot both be fired effectively at the same time. After firing one of the weapons in the combination, the shooter must take time to reposition his firing hand before firing the other weapon. Hence, the rifle is not available as an immediate back-up weapon, should the electronic weapon fail for any of a number of reasons to immobilize an assailant, or should the incident escalate to a point where use of lethal force becomes necessary. If the shooter held the trigger guard of the M-16 with one of his hands and the trigger guard of the M-203 weapon with the other of his hands to fire both weapons simultaneously or to have both weapons at the immediate ready for alternate firing, he would destabilize the entire M-16 and M-203 weapon platform.

Secondly, if the shooter held the combination in the latter manner, because of the hands' positioning, they would risk responsively firing a potentially lethal rifle burst when discharging the electronic discharge immobilization weapon. Consequently, a need exists for an improved firearm and electronic immobilization combination which addresses the problems of prior designs.

### SUMMARY OF THE INVENTION

The present invention improves upon the prior art by housing the electronic discharge immobilization weapon of the combination, so a shooter can support the forend of the long arm with which the immobilization weapon combines by grasping stock supports of the original long arm or after market devices intended to enchance the shooter's support of the long arm's forend. A long arm is defined as a rifle or a shot gun.

In one embodiment of the present invention, a TASER or electronic immobilization device and a vertical grip are combined to be attached to a stud post or rail under the forend or the barrel of a conventional long arm. A TASER or electronic immobilization device may also be combined with the forend or barrel of a conventional long arm itself. The TASER and vertical grip combination eliminates the TASER's earlier described storage and transport disadvantages. It also allows for the forend of the long arm to be supported as originally designed. It also eliminates many of the other of the TASER's problems described in U.S. Pat. No. 5,831,199 to McNulty. The TASER is less likely to be fired at an ineffectively close range because the firearm barrel extending beyond the TASER's launcher, serves as a stand off. Conventional firearms used for home protection need not be kept loaded, thereby, risking injury and death to innocent children and others, as the combined TASER can serve as the first line of home defense. If a TASER deployment should fail or if a confrontation should escalate, the peace officer or soldier would have the conventional firearm for immediate backup.

Alternatively, the electronic immobilization device can be mounted along the side of the barrel for applications including, or not including, other under-barrel attachments, such as a grenade launcher. In yet a further configuration, an electronic immobilization device can be integrated into a shotgun slide handle which is attached to a shotgun slide and at least one ring to the shotgun magazine, so the slide can be positioned to trigger mechanisms to load cartridges into and eject cartridges from the shotgun's chamber and where the electronic immobilization device can be fired when the slide is positioned to eject a cartridge from the shotgun's chamber. This configuration prevents accidental responsive firing of the shotgun and the shotgun remains properly supported as designed when it is racked forward and a cartridge is loaded into its chamber.

In any of the configurations, a trigger switch is positioned on a surface of the electronic immobilization device so that it can be fired with the extended thumb and/or extended and then flexed thumb of the grasping hand supporting the forend of the long arm with which the electronic immobilization device is combined. This design will greatly reduce the tendency of the shooter to responsively fire the long arm when firing the electronic immobilization device because the electronic immobilization device is not fired by the index or trigger finger. Furthermore, the electronic immobilization device can include a configuration where the trigger switch is positioned within a recess and can have a manual safety switch.

Moreover, the TASER may alternately serve as a signaling device or rescue beacon for both combatants or sportsmen in need of rescue. The TASER power supply can serve as a power source for a strobe lamp, which may be sighted by rescuers either visually or with infrared night viewing or other special viewing equipment for miles.

An optical signal could be produced in the infrared, visible light and ultraviolet light regions of the electromagnetic spectrum. Visible light occupies the region with wavelengths from approximately 400 nanometers to 700 nanometers. When produced outside of the visible light region of the spectrum, the signal would be visible to rescuers with special viewing equipment while the signaler remained concealed to less technically sophisticated enemies. The signal lamp is inserted into a TASER's firing chamber in lieu of an ammunition cartridge. The TASER power supply's high voltage output might alternatively be switched from the TASER's firing chamber to the lamp. It would be undesirable to operate both the lamp and shock circuits simultaneously as this would likely give away the combatants position to his enemies. With either configuration, after the lamp or beacon is switched on, the frequency of the power output might be decreased to extend operation time. When detached from the rifle, the forend grip lantern might also serve as a roadside hazard marker or as a landing zone marker for emergency helicopters.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 is a side view of the invention shown installed on an M-16 rifle;

FIG. 2 is a three-dimensional view of a vertical grip electronic immobilization device of the invention;

FIG. 3 is a side view of the embodiment of FIG. 2;

FIG. 4 is a top view of the embodiment of FIG. 2;

FIG. 5 is a partial perspective view of the embodiment of FIG. 2 with a strobe light installed in the invention instead of a TASER cartridge;

FIG. 6 is a partial side view of the invention shown on a rifle and being used to propel wire-tethered electrode darts toward a target;

FIG. 7 illustrates a military scenario for use of the embodiment with a strobe light or infrared light attachment;

FIG. 8 illustrates a non-military scenario similar to that of FIG. 7;

FIG. 9 is a perspective view of an alternative embodiment electronic immobilization device of the present invention;

FIG. 10 is a back view of the embodiment of FIG. 9;

FIG. 11 is a back view of an alternative configuration of FIG. 10;

FIGS. 12a and 12b illustrate the embodiment of FIG. 9 in use;

FIG. 13 is a front view of another alternative embodiment electronic immobilization device of the present invention; and

FIG. 14 is a side view of the invention in combination with a shotgun.

### DETAILED DESCRIPTION OF THE INVENTION

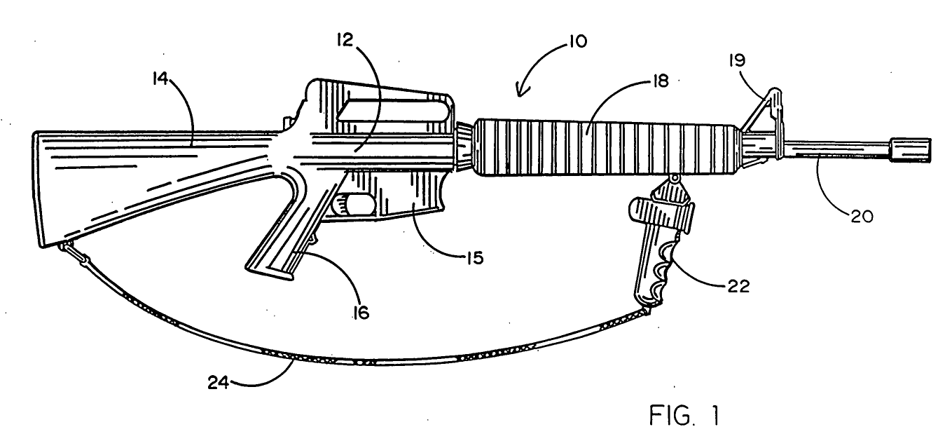

Referring to the accompanying drawings, and particularly FIG. 1, it will be seen that a rifle 10 comprises a main body 12, a butt stock 14, a magazine receptacle 15, a pistol grip 16, a hand guard 18 (hand guard may also be referred to as a forend, forend grip, forestock, forearm, or slide hand on long arms incapable of automatic or semi-automatic firing), a site 19, a barrel 20, a forend grip 22 and a sling 24. The rifle depicted in FIG. 1 will be recognized as an M-16-A2 semiautomatic rifle which is currently the U.S. military standard. However, the present invention is not limited to deployment in an M-16-A2 rifle, which is shown in FIG. 1 solely for purposes of illustrating a configuration of the invention and a method of attachment to a rifle. One aspect of the invention herein resides in the forend grip 22 which uniquely provides an additional and highly advantageous function of backup weapon and/or strobe light. A prior art standard vertical forend grip, such as that grip sold under the trademark “Steadyhold” by Steadyhold Products of Cedar Rapids, Iowa or the grip sold under the Trademark “Ergogrip” by Falcon Industries of Tijeras, New Mexico, is known in the firearms trade as an after-market accessory for rifles. It provides a comfortable additional holder for the non-trigger hand and adds a stabilizing function for better accuracy. It is typically a substantially monolithic, rubberized structure having means for attachment to the rifle along the barrel or hand guard.

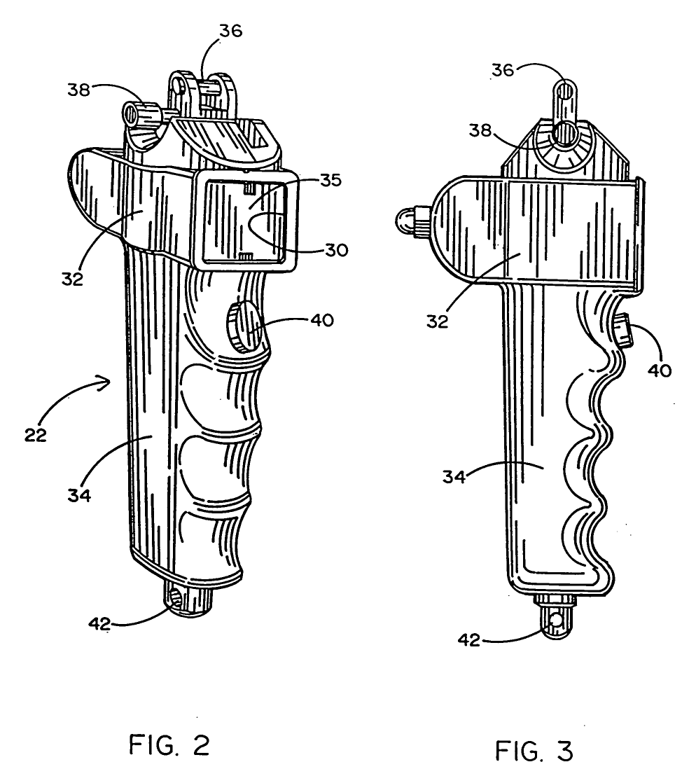

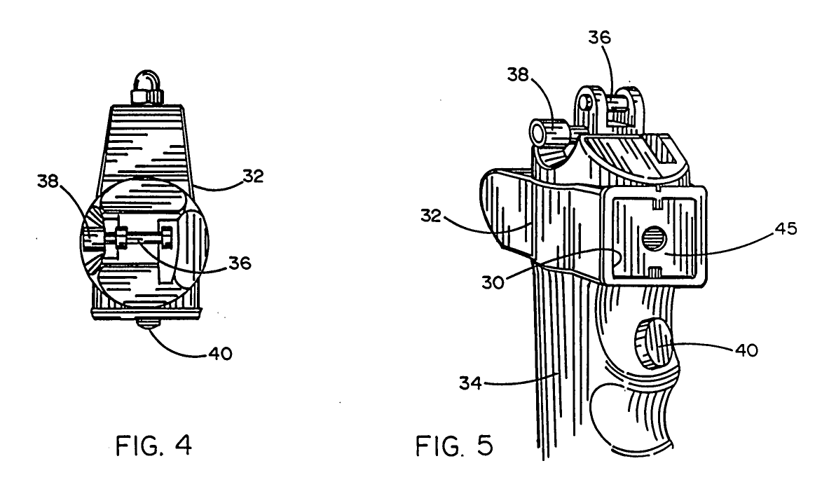

One embodiment of the present invention provides a vertical forend grip substitute which, for the most part, retains the external configuration of prior art grips. However, in the present invention the grip is configured to enclose a battery and electronics to house a TASER electronic immobilization weapon having a chamber for receiving a TASER cartridge. One embodiment of this unique, grip-configured TASER apparatus is seen best in FIGS. 2-5.

Grip 22 will be seen as comprising a chamber 30 in a housing 32 integrally constructed as a part of the grip body 34. The latter is hollow to provide an interior for receiving a battery and electronics (not shown) for TASER weapon operation. Such electronics are well known in the TASER art and need not be described herein in any detail. Suffice it to say that such electronics are substantially the same as those described in U.S. Pat. Nos. 3,803,463 and 4,253,132 to Cover, the content of which is hereby incorporated herein by reference as if fully set forth herein. Chamber 30 receives a standard two-wire tethered dart cartridge 35 which may be selectively activated by a trigger switch 40. Grip/TASER 22 is attached to the rifle using a grip latch 36 and a latch lock 38, both of which are prior art elements of the existing forend grip and need not be described herein in greater detail. A sling hook 42 permits the sling 24 to be attached to the grip/TASER 22 in a conventional manner.

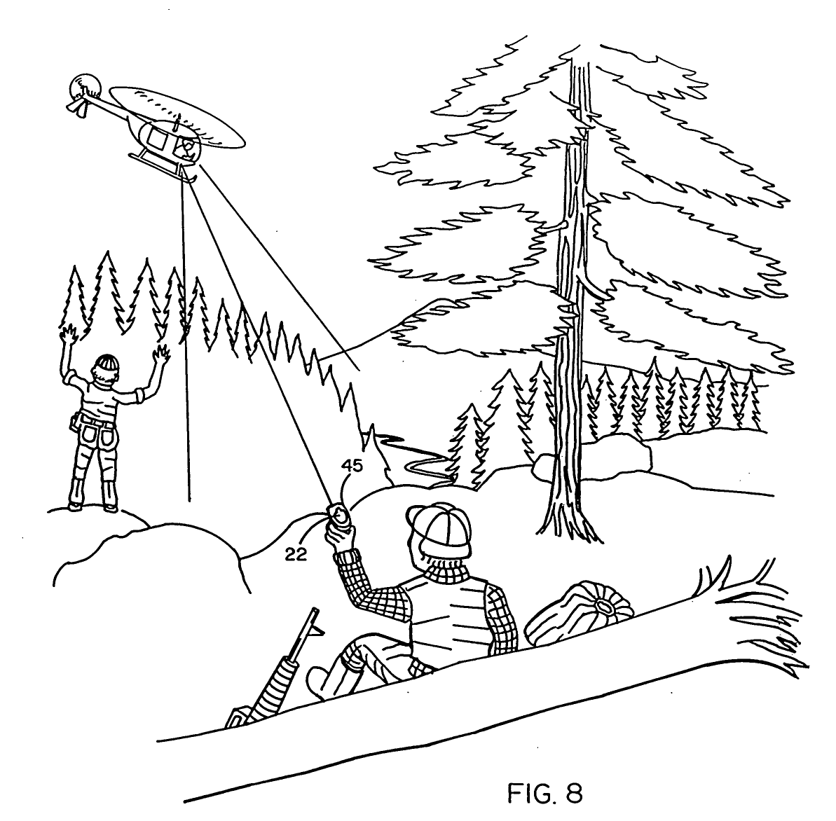

Because the TASER cartridge is typically activated by a high voltage pulsed signal, cartridge 35 may be replaced by a strobe light 45 as shown in FIG. 5 which is configured to operate at the same voltage and pulse rate to provide a visual signal as depicted in FIGS. 7 and 8. The light from strobe 45 may be either in the visual spectrum or in the infrared, the latter providing surreptitious optical signaling in a hostile environment. As shown in FIGS. 7 and 8, it may be desirable to remove grip TASER 22 from the rifle to facilitate its use as an optical signaling device.

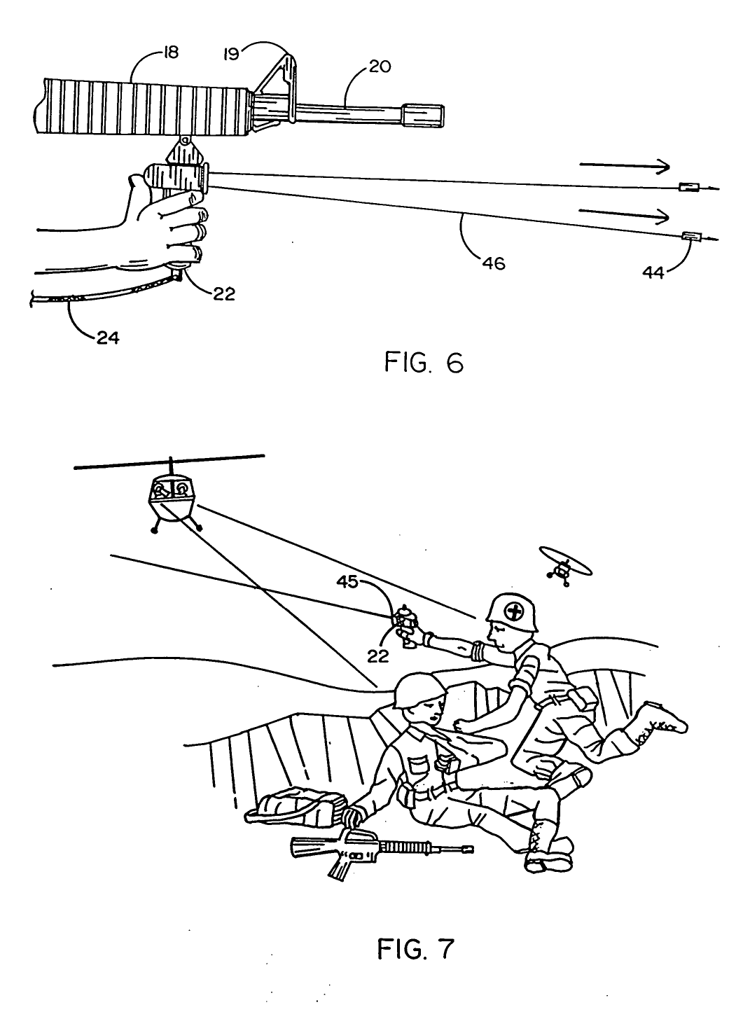

Operation of the invention is depicted in FIG. 6 which illustrates deployment of the grip/TASER 22 as an immobilization weapon. More specifically, the trigger switch 40 has been depressed thereby activating propellant in the cartridge 35 to propel darts 44 toward a target, each such dart being tethered by a thin wire 46 to the electronics in the grip/TASER body 34.

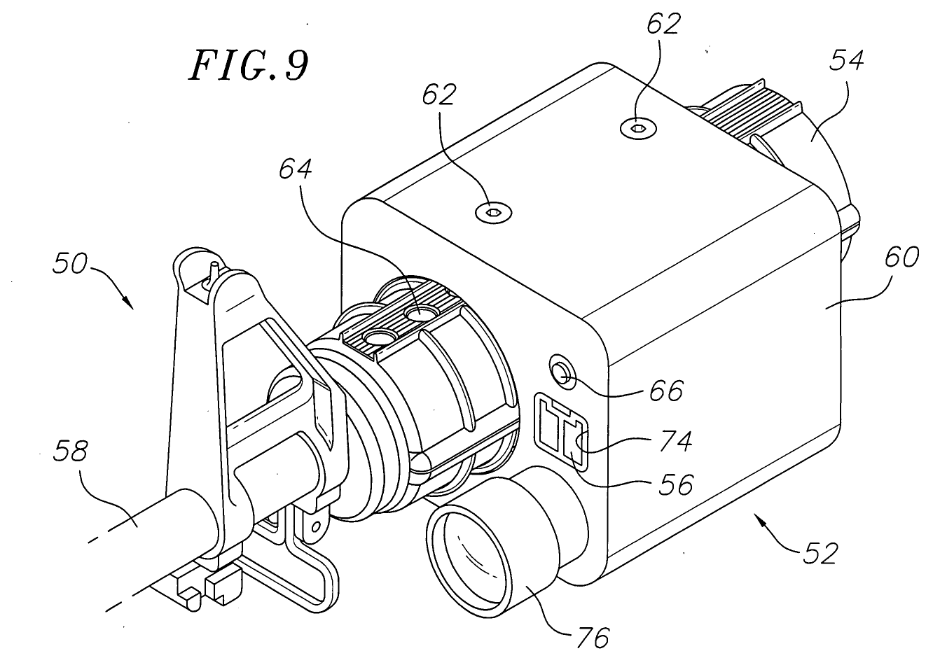

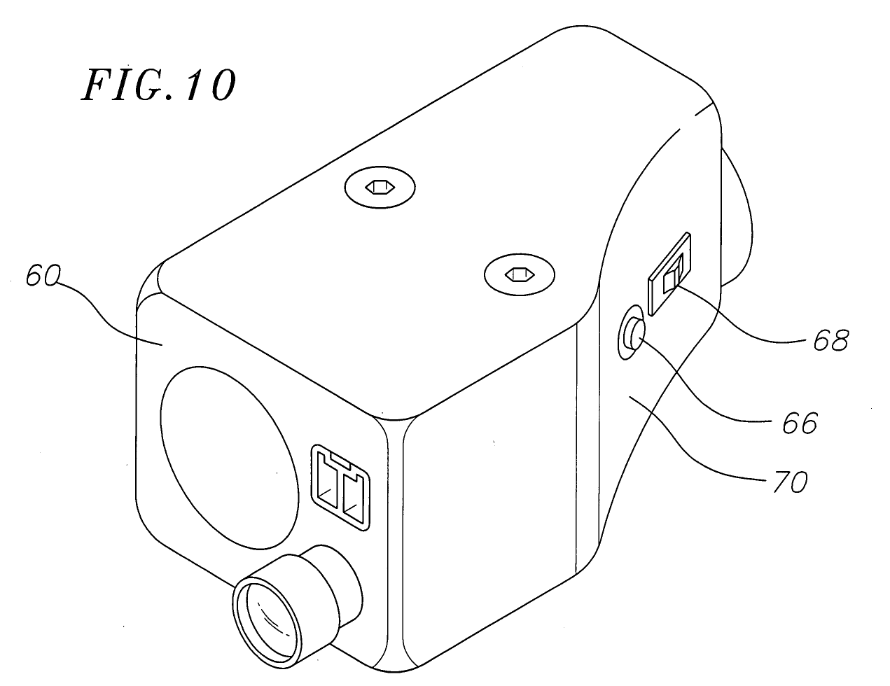

Referring to FIGS. 9 and 10, an alternative embodiment combination rifle 50 and electronic immobilization device 52 is shown. In this embodiment, electronic immobilization device 52 is attached to the hand guard 54 of the rifle such that the dart cartridge 56 is positioned along the side of the barrel 58 of the rifle. The electronic immobilization device 52 includes a housing 60 that extends over the top of the hand guard 54 and along the side of the hand guard. It is attached to the hand guard by fasteners 62 extending through the top surface of the housing and into holes 64 positioned along the top surface of the hand guard 54. The dart cartridge 56, which includes two-wire tethered darts, as previously discussed herein, may be selectively activated by a trigger switch 66 positioned on a front surface of the housing 60, as shown in FIG. 9. Alternatively, as can be seen in FIG. 10, the trigger switch 66 can be positioned on a rear surface of the housing 60 along with a safety switch 68. Both trigger 66 and safety 68 can be positioned in a contoured surface 70 on the housing based upon ergonomic considerations for activation by a thumb of the shooter. Although the trigger switch and the safety switch are illustrated on specific surfaces of the housing, it is to be understood that they can be positioned on any surface of the housing, depending upon the particular weapon or application for convenience and usability by the shooter.

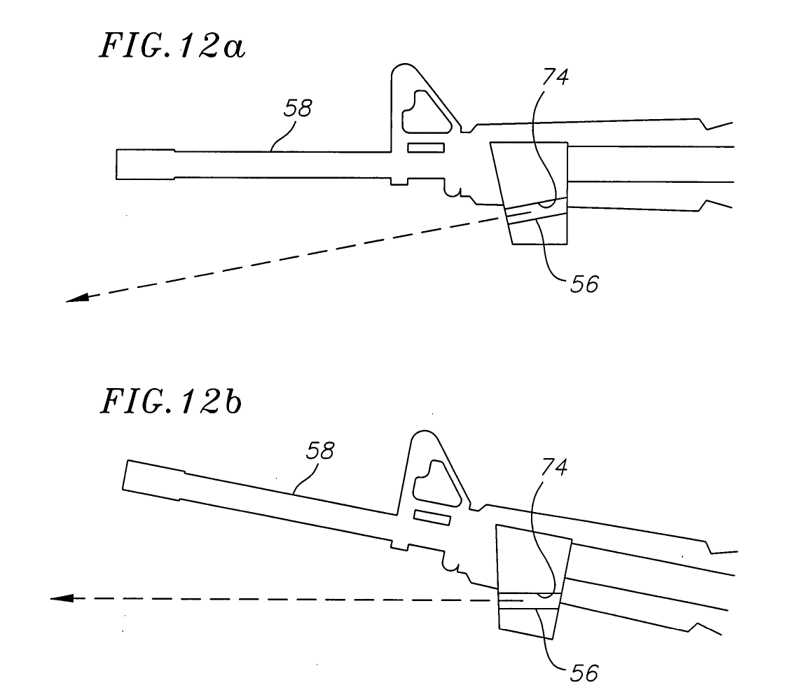

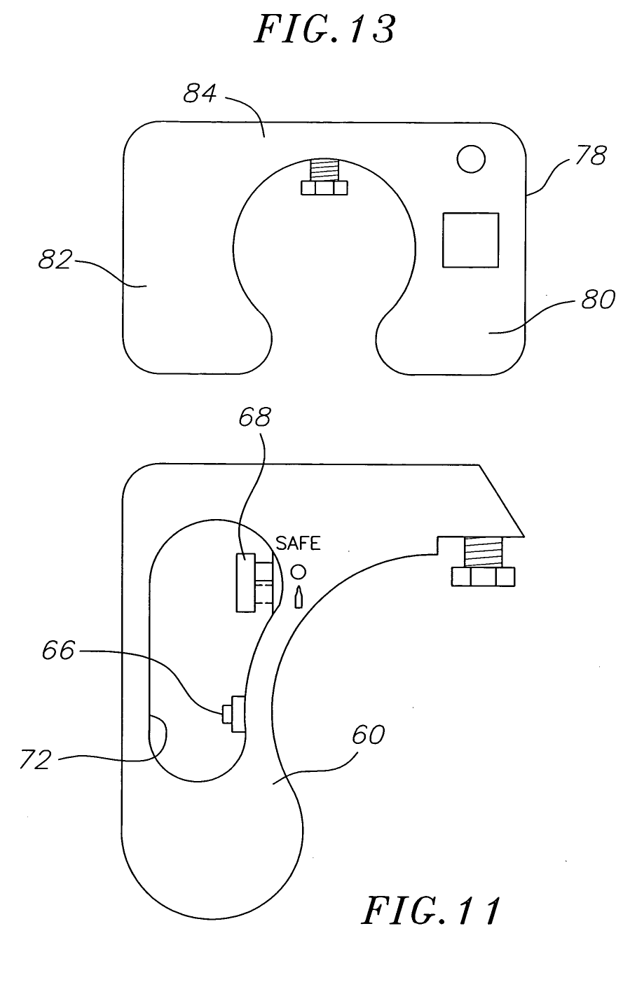

As shown in FIG. 11, the housing 60 also can include an aperture or recess 72 for positioning of the trigger switch 66 and safety 68. In this configuration, the trigger and safety are positioned within the recess to prevent accidental firing of the electronic immobilization device. As with the embodiment shown within FIGS. 1-8, the housing 60 includes an internal chamber to provide an interior for location of a battery and electronics (not shown). Housing 60 also includes a chamber 74 for receipt of the dart cartridge 56. As shown in FIGS. 12A and 12B, chamber 74 can be angled such that dart cartridge 56 is positioned such that the darts would be fired at an angle with respect to barrel 58. FIG. 12A illustrates the position of the combination weapon when firing the rifle, and FIG. 12B illustrates the position of the combination weapon when firing the electronic immobilization device. For firing the electronic immobilization device, the rifle barrel must be raised so that the darts are propelled towards the target. Such a configuration prevents an unwanted lethal round from being fired at the target accidentally during operation of the electronic immobilization device.

The housing 60 of the electronic immobilization device 52 may also include a laser site 76 for aiming of the darts. The chamber 74 also can be positioned within the housing at an angle in a horizontal plane and the laser 76 can be adjusted so that the darts are propelled at an angle with respect to the barrel which would require the rifle to be moved in a horizontal plane when the electronic immobilization device is operated. This configuration also would prevent accidental lethal rounds being fired at the target when the electronic immobilization device is operated. It is to be understood that the positioning of the chamber for receipt of the dart cartridge can be perpendicular, parallel or at an angle, depending upon its specific use. The discussion herein with respect to angling the chamber for receipt of the dart cartridge is optional as a safety precaution, however, there may be applications where this is not desired.

Although the electronic immobilization device 52 as shown in FIGS. 9-12 is L-shaped, it is to be understood that other shapes are also possible, such as a U-shape shown in FIG. 13. The U-shaped configuration 78 includes leg portions 80 and 82 along with a top portion 84. Leg portions 80 and 82 would extend along the sides of the hand guard of the rifle and the top portion 84 would extend over the top surface of the hand guard. In this configuration, typically one leg would include the dart cartridge, trigger and safety, while the other leg would include the battery and electronics. This configuration seeks to minimize the profile of the electronic immobilization device on either side of the rifle, yet allow for the darts to be fired from the side of the rifle and not interfere with other under-barrel devices. Operation of the weapons shown in FIGS. 9-13 is similar to that for the embodiments shown in FIGS. 1-8 wherein the trigger switch is depressed, thereby activating a propellant in the cartridge to propel darts toward the target, each such dart being tethered by a thin wire to the electronics located within the housing.

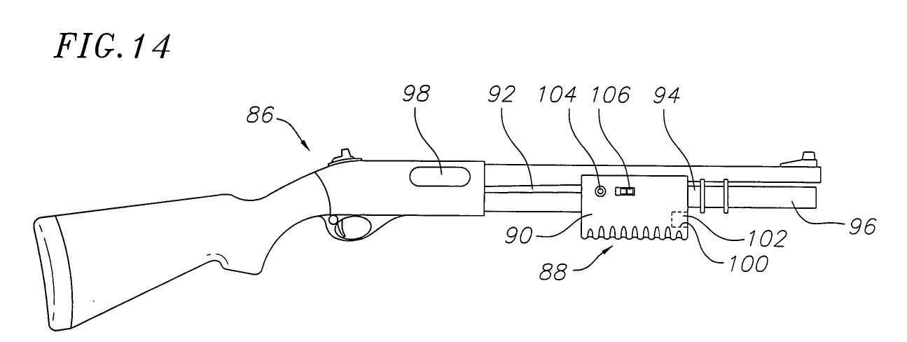

FIG. 14 illustrates yet another alternative embodiment combination weapon comprising a shotgun 86 and an electronic immobilization device 88. The electronic immobilization device is integrated into the slide handle 90, which is attached to a slide 92 by a ring 94 positioned around the magazine 96. The forearm and slide can be positioned and operates in a conventional manner to load shells and eject spent shells from the shotgun's chamber 98 and the electronic immobilization device 88 can be fired when the slide is positioned to eject a shell from the shotgun's chamber or in the fully extended position. By firing the electronic immobilization device when the slide is in the eject position prevents accidental responsive firing of the shotgun during firing of the electronic immobilization device.

The electronic immobilization device 88 is similar to the other embodiments disclosed herein and includes a chamber 100 for receipt of a dart cartridge 102. A trigger switch 104 and a safety 106 are positioned on an exterior surface of the device for firing of the darts. As with the other embodiments disclosed herein, the trigger mechanism and the safety can be positioned on a contoured surface or in a cavity as desired for a particular application. Similarly, power source and electronics are contained within the housing. The trigger switch preferably is positioned on a surface so that it can be fired with the extended thumb or extended and then flexed thumb or grasping hand supporting the forend of the shotgun. This will greatly reduce the tendency of the shooter to responsively fire the shotgun when firing the electronic immobilization device, since the electronic immobilization device is no longer capable of being fired with the index or trigger finger.

Having thus disclosed illustrative examples of the present invention, it will be understood that the disclosed embodiments are not limiting of the invention, but merely a description of its salient features in the presently contemplated best mode. By way of example, those having skill in the relevant art and having the benefit of applicant's teaching herein, will now perceive various modifications and additions which may be beneficial. Other structures, means for attachment to a rifle and activation will almost certainly come to mind, particularly in conjunction with other rifles. Thus, the scope hereof is to be limited only by the appended claims and their equivalents.

1. A combination weapon comprising:
a long arm having a barrel for firing a lethal projectile at a remote target;
a device positioned adjacent the barrel of the long arm for propelling at least one electrically charged immobilizing non-lethal dart at the remote target; and
a trigger switch positioned on a surface of the device to be operated by the hand grasping the hand guard of the long arm to support the long arm's forend and not the firing hand for the long arm.

2. The weapon of claim 1, wherein the device includes a vertical grip positioned below the barrel of the long arm.

3. The weapon of claim 1, wherein the trigger switch is positioned on a contoured surface of the device.

4. The weapon of claim 1, wherein the trigger switch is positioned in a recess in the device.

5. The weapon of claim 1, further comprising a safety mechanism for the device.

6. The weapon of claim 1, wherein the device includes a housing mounted to the long arm such that the dart is propelled from a side of the barrel.

7. The weapon of claim 6, wherein the housing extends on either side of the barrel and across the top of the barrel.

8. The weapon of claim 6, wherein the housing has a chamber for receipt of a cartridge containing the dart.

9. The weapon of claim 8, wherein the chamber is positioned in the housing at an angle.

10. The weapon of claim 1, wherein the long arm is a shotgun having a slide and the device is attached to the slide below the barrel.

11. The weapon of claim 10, wherein the device is operable when the slide is in an eject position.

12. A rifle having a barrel and an electronic immobilization device positioned adjacent the barrel, wherein the electronic immobilization device has a trigger mechanism on a surface of the device which is positioned such that it is to be fired by a hand which does not fire the rifle.

13. The rifle of claim 12, wherein the electronic immobilization device includes a vertical grip positioned below the barrel.

14. The rifle of claim 12, wherein the trigger mechanism is positioned on a contoured surface of the electronic immobilization device.

15. The rifle of claim 12, wherein the trigger mechanism is positioned in a recess in the device.

16. The rifle of claim 12, further comprising a safety mechanism for the electronic immobilization device.

17. The rifle of claim 12, wherein the electronic immobilization device includes a housing mounted to the rifle, such that a dart can be propelled from the electronic immobilization device along a side of the barrel.

18. The rifle of claim 17, wherein the housing extends on either side of the barrel and across a top of the barrel.

19. The rifle of claim 17, wherein the housing has a chamber for receipt of a cartridge containing the dart.

20. The rifle of claim 19, wherein the chamber is positioned in the housing at an angle.

21. A shotgun having a barrel, a slide, a slide handle and an electronic immobilization device positioned adjacent the barrel integral with the slide handle, the electronic immobilization device having a trigger mechanism on a surface of the integration device which is positioned such that it is to be operated by a hand which supports the slide handle.

22. The shotgun of claim 21, wherein the shotgun further has a slide and the electronic immobilization device is attached to the slide below the barrel.

23. The shotgun of claim 22, wherein the electronic immobilization device is operable when the forearm slide is in an eject position.
